(19) United States
(12) Patent Application Publication
(10) Pub. No.: US 2011/0141622 A1
(43) Pub. Date: Jun. 16, 2011

(54) HEAD SLIDER WITH A POCKET FOR SUPPRESSING VARIABILITY IN LEVITATION

(76) Inventor: Yoshinori Takeuchi, Ibaraki (JP)

(21) Appl. No.: 12/966,439

(22) Filed: Dec. 13, 2010

(30) Foreign Application Priority Data
Dec. 14, 2009 (JP) 2009-283102

(51) Int. Cl. G11B 5/60

(52) U.S. Cl. 360/235.4; G9B/5.229

(57) ABSTRACT

A head slider with a pocket. An air bearing surface. A central levitating surface. A magnetic recording head provided in proximity to a trailing edge side of the central levitating surface. A deep recessed surface provided on both sides of the head slider in a width direction of the head slider with respect to the central levitating surface, wherein the deep recessed surface is configured to generate negative air pressure. A second deep recessed surface extending from a leading edge side of the central levitating surface. A levitating surface provided on a leading edge side of the deep recessed surface and a second levitating surface provided between the deep recessed surface and the second deep recessed surface, wherein the pocket is provided whose depth from the levitating surface and the second levitating surface is deeper than a periphery immediately in front of a terminus of the second deep recessed surface.

### CROSS-REFERENCE TO RELATED APPLICATION

This application claims priority from the Japanese Patent Application No. 2009-283102, filed Dec. 14, 2009, the disclosure of which is incorporated herein in its entirety by reference.

### TECHNICAL FIELD

Embodiments of the present technology relate to head slider with a pocket for suppressing variability in levitation, and related in particular to a head slider that is coupled with a magnetic recording head and is a component of a disk drive.

### BACKGROUND

Modern magnetic disk devices include head sliders. In attempt to reduce cost, some disk devices employ miniature sliders (called “femtosliders” of for example length 0.85 mm×width 0.7 mm×thickness 0.23 mm). Such head sliders may employ an ABS (air bearing surface). Various methods and techniques have been employed with ABSs to generate negative air pressure. Such techniques have often lead to variations and changes in the air supply and distribution which leads to variability in the levitation of the slider above the disk.

Further, in order to improve the recording/reproduction characteristics and improve recording density, the technique has come to be adopted of calibrating the clearance of each head by using a thermal actuator (TFC) to bring the slider element section into contact with the medium, then pulling up the head by the amount of the prescribed clearance, and bringing the vicinity of the element into the vicinity of the medium at about 1 to 2 nm distance during recording/reproduction. With this method, the amount of levitation of the element section can always be kept constant, but, in the case of a slider of reduced levitation performance, it becomes impossible to maintain the aforesaid clearance if the height is large.

### SUMMARY

A head slider with a pocket. An air bearing surface. A central levitating surface provided in a center region of the head slider in a width direction at a trailing edge side of the head slider. A magnetic recording head provided in proximity to a trailing edge side of the central levitating surface. A deep recessed surface provided on both sides of the head slider in a width direction of the head slider with respect to the central levitating surface, wherein the deep recessed surface is configured to generate negative air pressure. A second deep recessed surface extending from a leading edge side of the central levitating surface. A levitating surface provided on a leading edge side of the deep recessed surface and a second levitating surface provided between the deep recessed surface and the second deep recessed surface, wherein the pocket is provided whose depth from the levitating surface and the second levitating surface is deeper than a periphery immediately in front of a terminus of the second deep recessed surface.

### DESCRIPTION OF THE DRAWINGS

The accompanying drawings, which are incorporated in and form a part of this specification, illustrate embodiments of the present technology and, together with the description, serve to explain the embodiments of the present technology:

FIG. 1 is a block diagram of a plan view showing the concept of an air bearing face of a head slider, in accordance with an embodiment of the present technology.

FIG. 2A is a block diagram of a cross sectional view of a head slider, in accordance with an embodiment of the present technology.

FIG. 2B is a block diagram of a cross sectional view of a head slider, in accordance with an embodiment of the present technology.

FIG. 3 is a block diagram of a plan view showing the air bearing face of a head slider, in accordance with an embodiment of the present technology.

FIG. 4 is a block diagram of a detail view of a head slider, in accordance with an embodiment of the present technology.

FIG. 5A is a block diagram of a cross sectional view of a head slider, in accordance with an embodiment of the present technology.

FIG. 5B is a block diagram of a head slider, in accordance with an embodiment of the present technology.

FIG. 6A is a block diagram showing the flow of air over a head slider, in accordance with an embodiment of the present technology.

FIG. 6B is a block diagram of a diagram showing the flow of air over a head slider, in accordance with an embodiment of the present technology.

FIG. 7 is a block diagram of the pressure distribution of the air bearing face, in accordance with an embodiment of the present technology.

FIG. 8 is a block diagram of the levitation variation reducing effect, in accordance with an embodiment of the present technology.

FIG. 9A is a block diagram of a plan view diagram showing an air bearing surface of a head slider, in accordance with an embodiment of the present technology.

FIG. 9B is a block diagram of a cross sectional view of a head slider, in accordance with an embodiment of the present technology.

FIG. 10A is a block diagram of a plan view diagram showing an air bearing face of a head slider, in accordance with an embodiment of the present technology.

FIG. 10B is a block diagram of a cross sectional view of a head slider, in accordance with an embodiment of the present technology.

FIG. 11A is a block diagram of a plan view diagram showing an air bearing surface of a head slider, in accordance with an embodiment of the present technology.

FIG. 11B is a block diagram of a cross sectional view of a head slider, in accordance with an embodiment of the present technology.

FIG. 12A is a block diagram of a plan view diagram showing an air bearing surface of a head slider, in accordance with an embodiment of the present technology.

FIG. 12B is a block diagram of a cross sectional of a head slider, in accordance with an embodiment of the present technology.

FIG. 13 is a block diagram of a bird's eye view of a disk drive in which a head slider is mounted, in accordance with an embodiment of the present technology.

The drawings referred to in this description should not be understood as being drawn to scale except if specifically noted.

### DESCRIPTION OF EMBODIMENTS

Reference will now be made in detail to the alternative embodiments of the present technology. While the technology will be described in conjunction with the alternative embodiments, it will be understood that they are not intended to limit the technology to these embodiments. On the contrary, the technology is intended to cover alternatives, modifications and equivalents, which may be included within the spirit and scope of the technology as defined by the appended claims.

Furthermore, in the following description of embodiments of the present technology, numerous specific details are set forth in order to provide a thorough understanding of the present technology. However, it should be noted that embodiments of the present technology may be practiced without these specific details. In other instances, well known methods, procedures, and components have not been described in detail as not to unnecessarily obscure embodiments of the present technology. Throughout the drawings, like components are denoted by like reference numerals, and repetitive descriptions are omitted for clarity of explanation if not necessary.

Embodiments of the present technology may be practiced in a disk drive comprising a head slider. It should be appreciated that a disk drive may be, but is not limited to a hard disk drive, a magnetic disk drive, etc. It should be appreciated that a head slider may be a magnetic head slider that may be coupled with a magnetic recording head that is used to perform read and write operations in relation to a disk.

Embodiments of the present technology describe surfaces that are deep, shallow, recessed, a pocket, levitating, central levitating, etc. Such surfaces should be understood to be surfaces of a head slider. In some embodiments, a recessed surface may also be described as a groove.

### Example 1

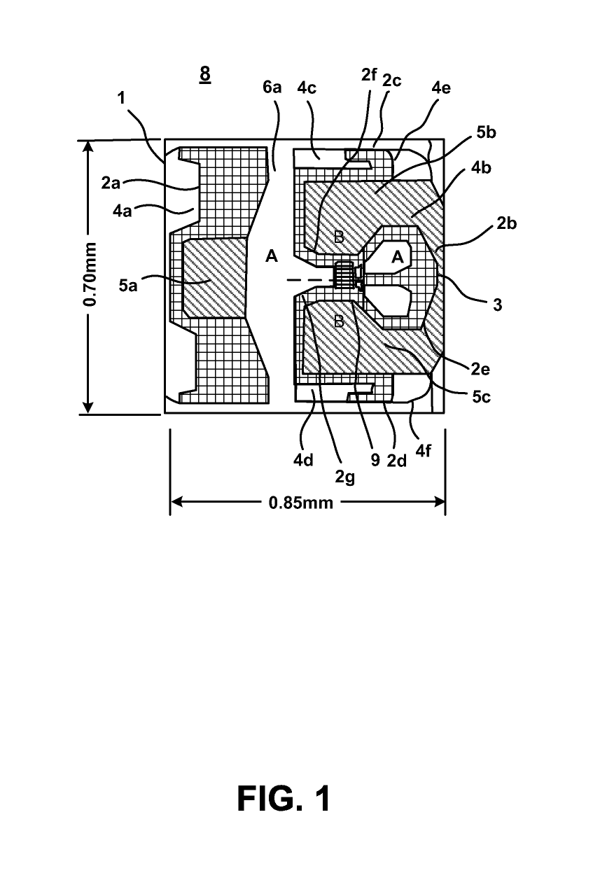

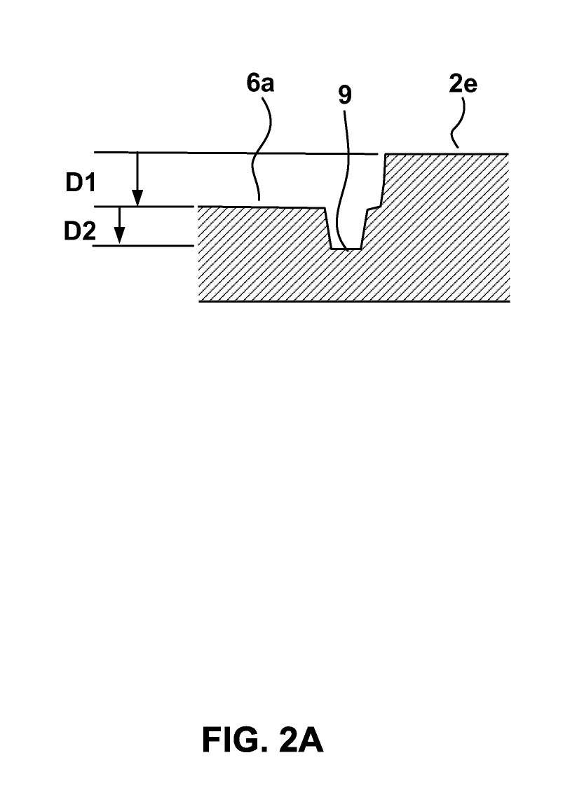

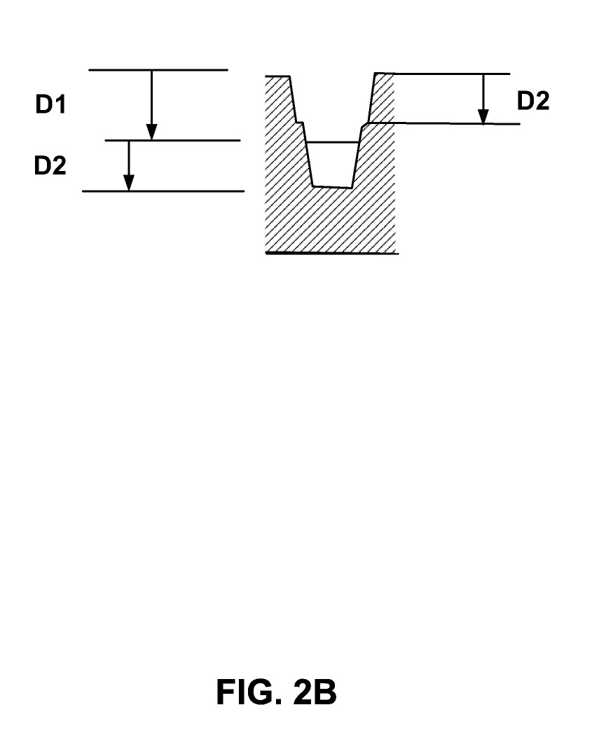

FIG. 1 is a plan view showing the concept of an air bearing surface (ABS) of a head slider according to the present invention. FIG. 2A is a cross sectional diagram along the line A-A of FIG. 1, showing the cross sectional shape of the pocket portion in the longitudinal direction of the slider. FIG. 2B is a cross sectional diagram along the line B-B of FIG. 1, showing the cross sectional shape of the pocket portion in a direction orthogonal to the cross section of FIG. 2A.

The slider 1 is a slider of for example the size known as a femtoslider and is of substantially rectangular solid shape of length 0.85 mm, width 0.70 mm and thickness 0.23 mm, and comprises a total of six surfaces facing the disk, as shown in FIG. 1, namely, an air bearing surface 8, an leading edge side from the left side in the Figure, an air trailing edge side surface from the right side, two side surfaces, and a rear surface. In the air bearing surface 8, a minute step (step bearing) is provided by a process such as ion milling or etching, so as to generate air pressure facing the disk and thereby playing the role of an air bearing that supports the load that is imposed on the back surface of the slider.

The surfaces that are provided with steps may be substantially divided into four types of parallel surfaces facing the same direction; these four types comprise: the levitating surfaces 2 (2a, 2b, 2c, 2d, 2e, 2f, 2g) that are closest to the disk, the shallow recessed surfaces 4 (4a, 4b, 4c, 4d, 4e, 4f) constituting step bearing surfaces of depth about 100 nm to 200 nm from the levitating surfaces 2; the deep recessed surfaces 5 (5a, 5b, 5c) that are about 1 μm deeper than the levitating surfaces 2; and a second deep recessed surface 6 (6a) that is about 2 μm to 4 μm deeper than the levitating surfaces. When the air current generated by rotation of the disk penetrates from the shallow recessed surfaces 4a, 4b, 4c, 4d constituting the step bearings of the air bearing phase 8 to the levitating surfaces 2a, 2b, 2c, 2d, it is compressed by the tapered flow path constituted by the shape of the parallel surfaces, giving rise to positive air pressure. In contrast, negative air pressure is generated by expansion of the flow path when the air current penetrates from the levitating surfaces 2f, 2g to the deep recessed surfaces 5b, 5c etc.

A central levitating surface 2b is provided in the center in the width direction of the trailing edge side of the slider 1 and a magnetic recording head 3 is mounted close to the air trailing edge side of this central levitating surface 2b. A second deep recessed surface 6a is provided between the inlet side levitating surface 2a and the central levitating surface 2b. In this way, whereas, conventionally, the characteristics of the front and rear levitating surfaces are linked so that they have a mutual effect upon each other, the second deep recessed surface 6a has the action of a separation zone whereby the characteristics of the front and rear levitating surfaces can be designed substantially independently. Also, the second deep recessed surface 6a extends right up to the front of the central levitating surface 2b in the middle of the slider. Also, both sides thereof are enclosed by levitating surfaces 2f, 2g of narrow width enclosing the deep recessed surface 5b, 5c configured to generate negative air pressure. Due to this construction, the extended portion of the second deep recessed surface 6a constitutes a second deep recessed surface whereby sufficient air is directed onto the step bearing comprising the central shallow recessed surface 4b and the central levitating surface 2b, and thus plays the role of generating a large positive pressure. Also, a peninsula-shaped levitating surface 2e that reaches the extended portion of the second deep recessed surface 6a from the central levitating surface 2b has an action of making the distribution of the positive pressure that is generated by the central levitating surface 2b low in the middle and high at the two sides in the width direction, in the vicinity of the element: thus it reduces the change in the amount of levitation when the element section is made to project by operating the thermal actuator. In this way, it has the effect of increasing the efficiency of projection of the thermal actuator.

In the second deep recessed surface 6a, a pocket 9 constituting a depression of substantially elongate rectangular shape is provided in front of the portion extending to in front of the central levitating surface 2b in the central portion of the slider. As shown in FIG. 2A, which is a cross section along the line A-A in the longitudinal direction of the slider, the pocket 9 has a depth D2 with respect to the second deep recessed surface 6a of depth DI from the levitating surface. As shown in FIG. 2B, which is a cross section along the line B-B in the direction perpendicular to FIG. 2A, the portion of the pocket 9 that communicates with the levitating surfaces 2f, 2g enclosing the deep recessed surface configured to generate negative air pressure constitutes a recess of depth D2 from the levitating surfaces. This is because this is formed by processing such as ion milling or etching, as described above. It should be noted that the depth of this recess is shown in exaggerated fashion in FIG. 2A and FIG. 2B.

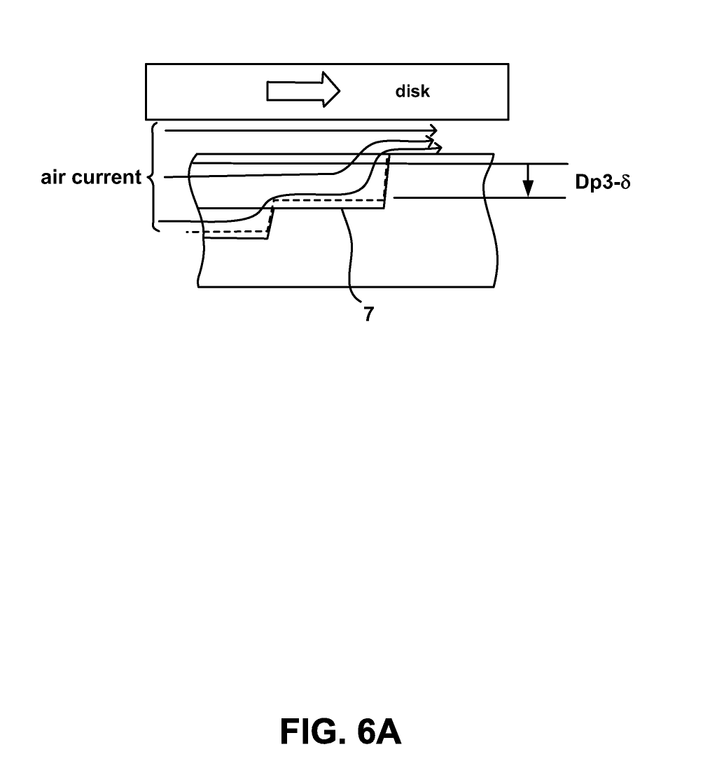

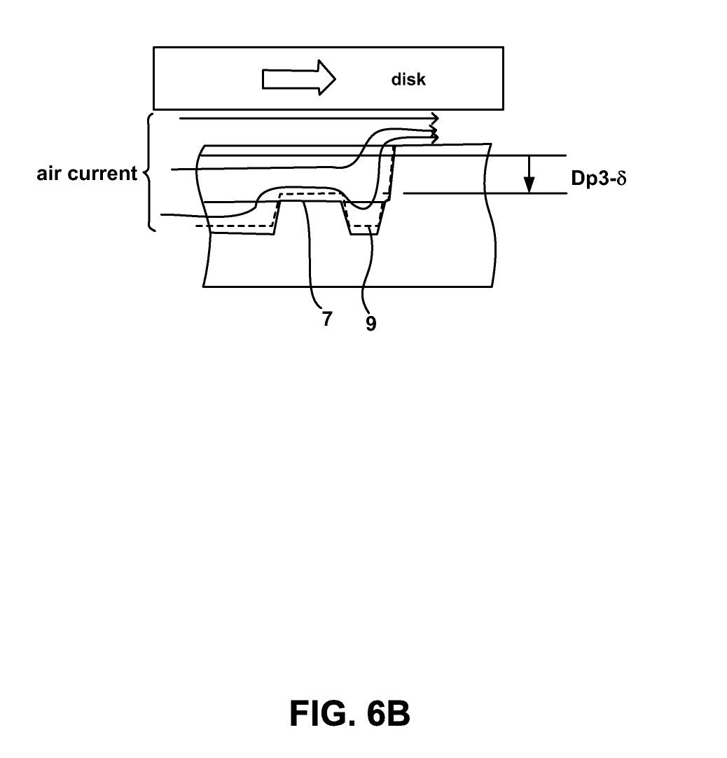

The beneficial effect of the provision of the pocket 9 will be described later, with reference to FIG. 6A and FIG. 6B.

### Example 2

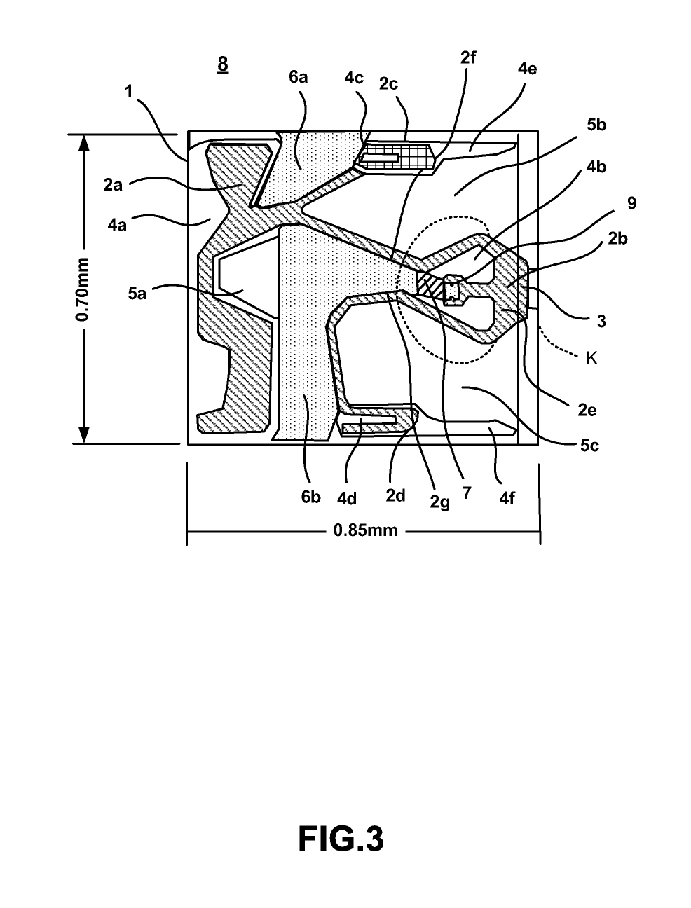

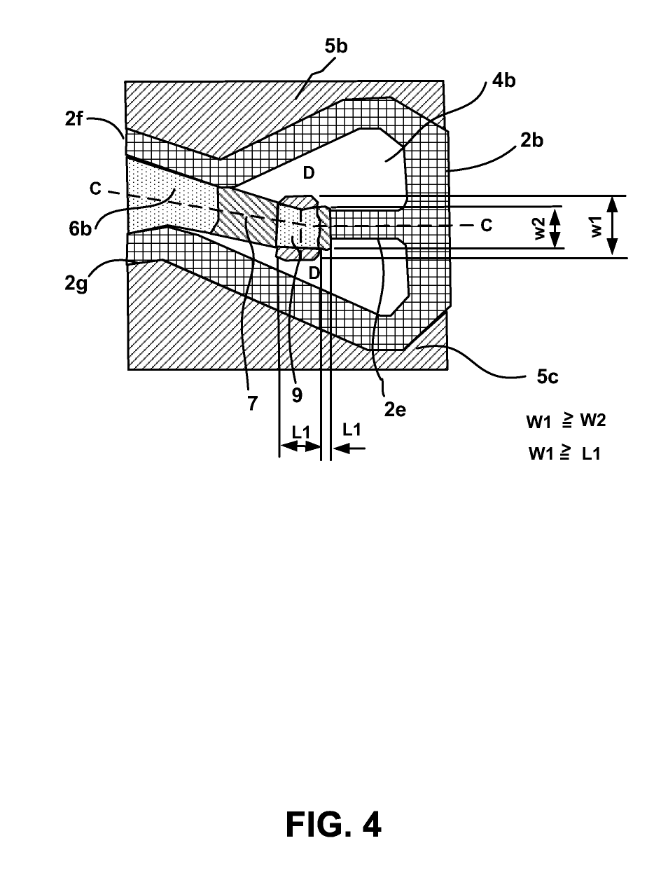

FIG. 3 is a diagrammatic plan view showing the ABS of a head slider according to another embodiment of the present invention. Second deep recessed surfaces 6a, 6b are arranged so as to divide the front and rear levitating surfaces 2a, 2b of the slider 1 substantially in the middle. The present embodiment is an example in which the second deep recessed surface is divided into two regions by the levitating surface 2. The second deep recessed surface 6b is sandwiched by the levitating surfaces 2f, 2g of narrow width enclosing the deep recessed surface configured to generate negative air pressure; substantially the middle of the slider is extended in the direction of the central levitating surface 2b; a third deep recessed surface 7 that is one level shallower than the second deep recessed surface extends from an intermediate position thereof as far as the inlet side of the central levitating surface 2b. The pocket 9 is provided, leaving a distance L2 (see FIG. 4) from the trailing edge side of the third deep recessed surface 7. In one embodiment, it is desirable that the depth of the pocket 9 from the levitating surface is the same as the depth of the second deep recessed surface from the levitating surface. This is because, in this way, the pocket can be more efficiently produced by the 10 processing method described above.

FIG. 4 is a detail view of the section K indicated by the broken lines in FIG. 3. The width W1 of the pocket 9 is about 62 μm and its length L1 is about 35 μm, Also, the width W2 at the tip of the third deep recessed surface 7 is about 46 u μm and the distance L2 from the pocket 9 to the tip of the third deep recessed surface 7 is about 11 μm. In one embodiment, it is desirable that the width W1 of the pocket 9 is at least the width W2 at the tip of the third deep recessed surface 7. This construction has the benefit of reliably reducing variability of levitation, as will be described. Also, in order to reduce levitation variability without causing deterioration in the levitation performance, W1 is at least L1. In one embodiment, it is desirable that L2 is set to a nominal value of at least 10 μm, so that L2>0, even if variability of the processing mask should occur.

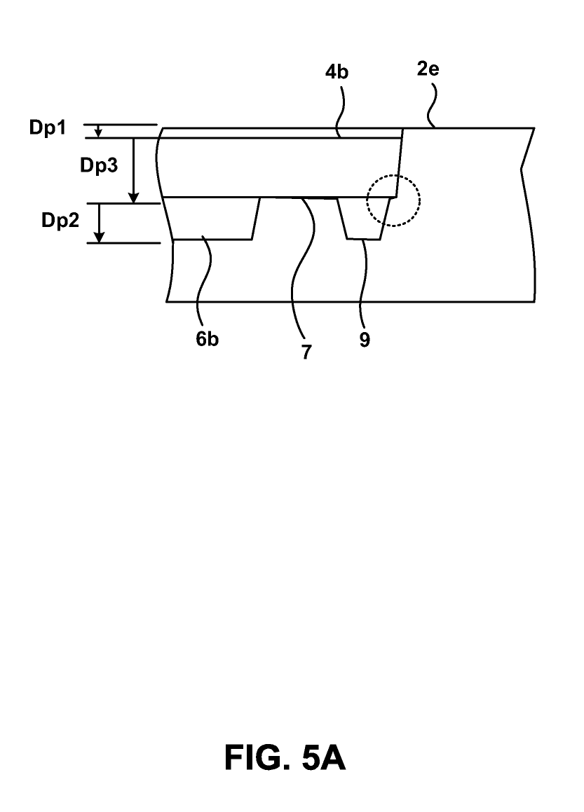

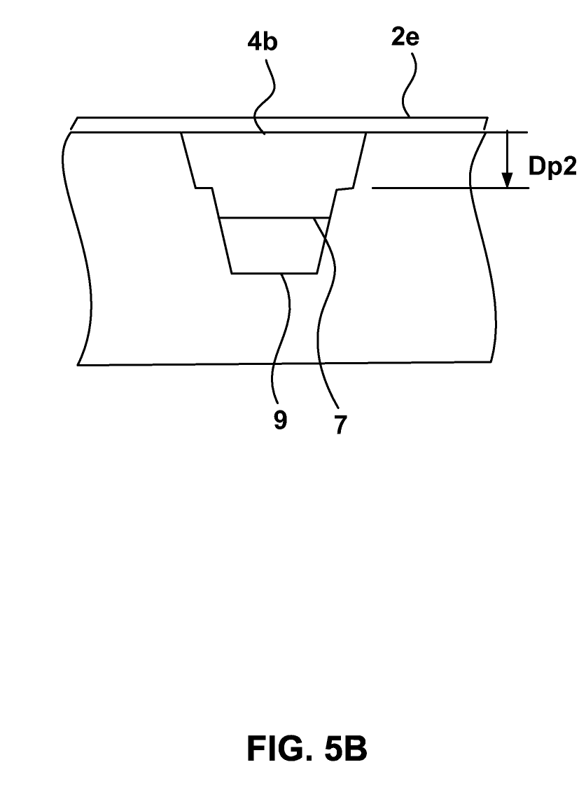

FIG. 5A is a diagrammatic cross sectional view showing a cross section along the line C-C of FIG. 4. The slider of this embodiment is created by three etchings, using three etching masks. The amount of processing in each etching is as follows: the added amount Dp1 of the first mask is about 140 nm, the added amount Dp2 of the second mask is about 750 nm and the added amount Dp3 of the third mask is about 1700 nm. The depths of each of the surfaces in the case of this embodiment are as follows: the depth of the shallow recessed surface 4 is about 140 nm, the depth of the deep recessed surface 5 from the levitating surface is about 890 run, the depth of the second deep recessed surface 6 and the pocket 9 from the levitating surface is about 2590 nm, and the depth of the third deep recessed surface 7 is about 1840 nm. In order to decrease the sensitivity of levitation with respect to height, the depth of the third deep recessed surface 7 is no more than 2000 nm. Since the pocket 9 is formed on the upstream side of the third deep recessed surface 7 with a distance L2 from the trailing edge side thereof, as shown by the broken lines, a step is formed between the peninsula-shaped levitating surface 2e and the pocket 9. FIG. 5B is a diagrammatic cross sectional view showing a cross section along the line D-D of FIG. 4. The depth of the pocket in the portion where the pocket 9 adjoins the central shallow recessed surface 4b is Dp2.

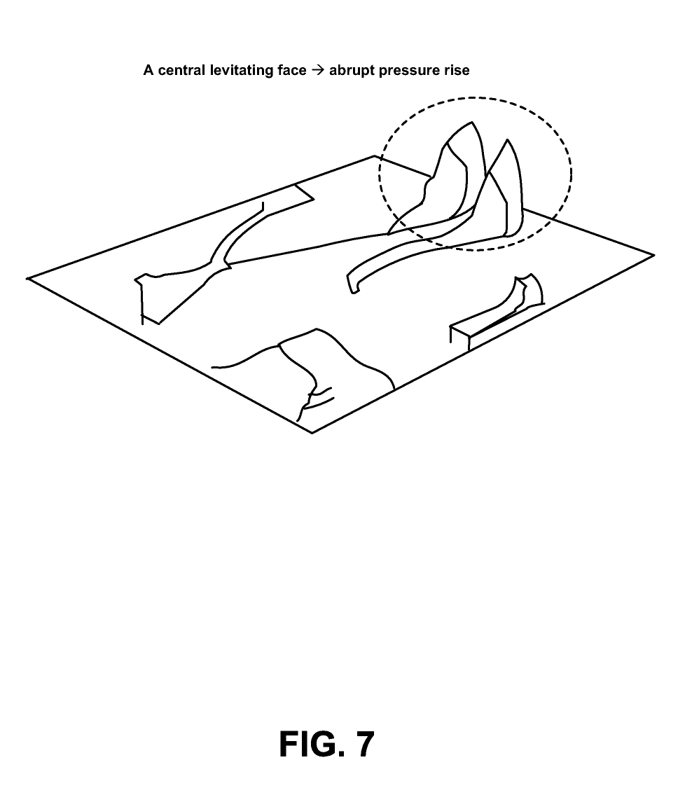

Next, the function of the pocket according to the present construction will be described. FIG. 7 shows the pressure distribution generated in a slider with the present construction. It can be seen that an abrupt increase in positive pressure is generated at the central levitating surface by the step bearing comprising central shallow recessed surface 4b and the central levitating surface 2b. This rise in pressure is made possible by the supply of air by the second deep recessed surface provided by the third deep recessed surface 7.

FIG. 6A and FIG. 6B are views given in explanation of the action and effect when there is no pocket and when a pocket according to the present invention is provided. FIG. 6A shows the flow of air when there is no pocket. When there is no pocket, the air penetrates into the third deep recessed surface 7 sandwiched by the levitating surfaces on both sides and flows along a shape of a fixed depth to the central levitating surface, and a large positive pressure is generated by compression. As shown by the dotted line in the Figure, if the recess depth of the third deep recessed surface 7 is made shallower by an amount 0, the amount of air supplied is reduced to a corresponding extent, causing a drop in the pressure generated at the central levitating surface and diminishing the amount of levitation of the element section.

In contrast, FIG. 6B shows the flow of air when the head slider has a pocket 9, according to the present invention is provided. In this case, the pocket 9 acts as a buffer for the air supply and, as shown by the dotted line in the Figure, has the beneficial effect of reducing the effect of fluctuation of the recess depth by the amount of the depth of the pocket 9, even if the recess depth of the third deep recessed surface 7 is shallower by an amount o. Likewise, by setting the width of the top of the pocket 9 to at least the width of the third deep recessed surface 7, the pocket 9 has a buffering action in respect of variations in the amount of air supply caused by positional offset between the third deep recessed surface 7 and the central levitating surface 2b, or variations in the distribution of such air supply, and thereby reduces the extent of variation in the pressure generated by the central levitating surface 2b. In this way, it has the beneficial effect of reducing variation in levitation of the element section.

The present embodiment is an example in which the peninsula-shaped levitating surface 2e reaches the third deep recessed surface 7 with this construction, the pressure distribution diagram of the pressure at the bearing surface, as shown in FIG. 7, is a distribution in which the positive pressure generated at the central levitating surface 2b is lower in the middle and higher at both sides in the width direction in the vicinity of the element, so variation in the amount of levitation when the thermal actuator is made to project is reduced, making it possible to increase the efficiency of such projection.

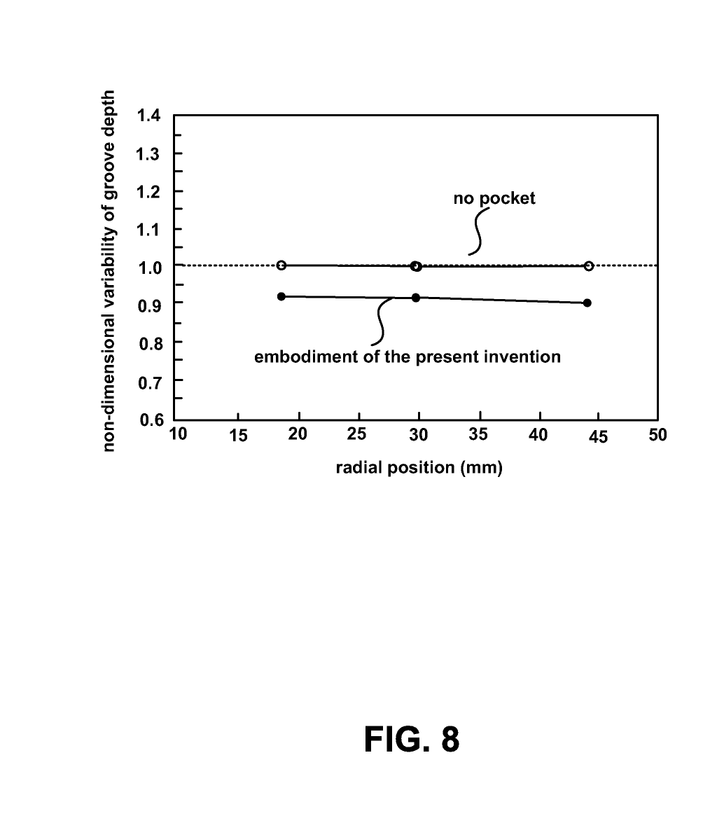

Regarding the variation of levitation with respect to recess depth of the third deep recessed surface 7, FIG. 8 shows a comparison in the variation of the levitation when a pocket according to the present invention is provided, taking the levitation variation when there is no pocket as being 1. An improvement effect of about 10% is obtained at the inner, middle and outer peripheral positions by the construction of the present invention.

### Example 3

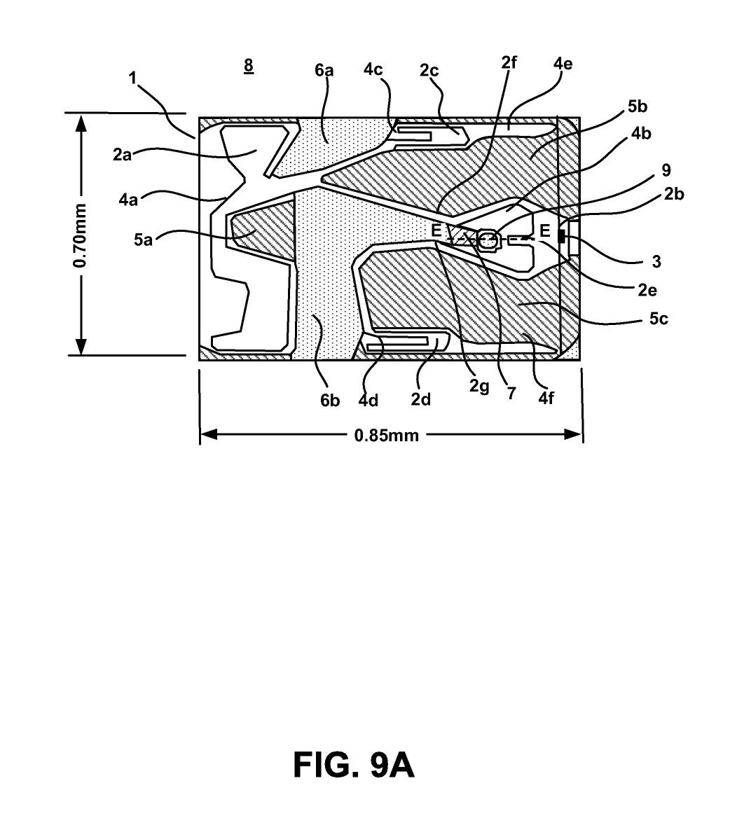

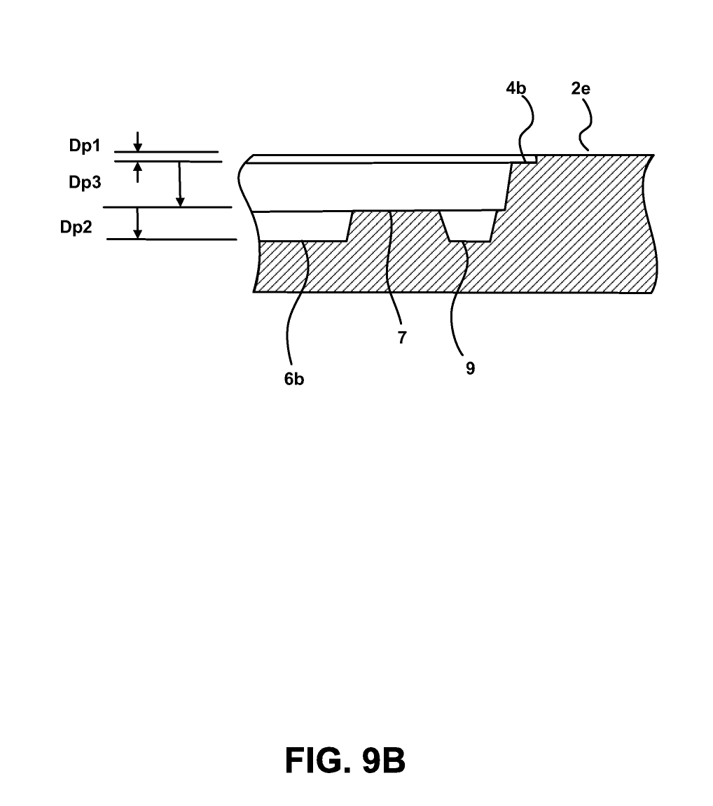

FIG. 9A is a diagrammatic plan view showing the ABS of a head slider according to another embodiment of the present invention. This embodiment is an example of a construction in which a peninsula-shaped levitating surface 2e of the central levitating surface 2b reaches the third recessed surface 7. FIG. 9B is a view showing a cross section along the line E-E of FIG. 9A. A central shallow recessed surface 4b of depth D1 from the levitating surface is provided between the third deep recessed surface 7 in front of the pocket 9 and the peninsula-shaped levitating surface 2e. With this construction, since the pressure distribution at the central levitating surface 2b is a maximum in the middle, even though the projection efficiency of the thermal actuator is a little less, the same beneficial effect as in the case of the first embodiment can be obtained with the present construction.

### Example 4

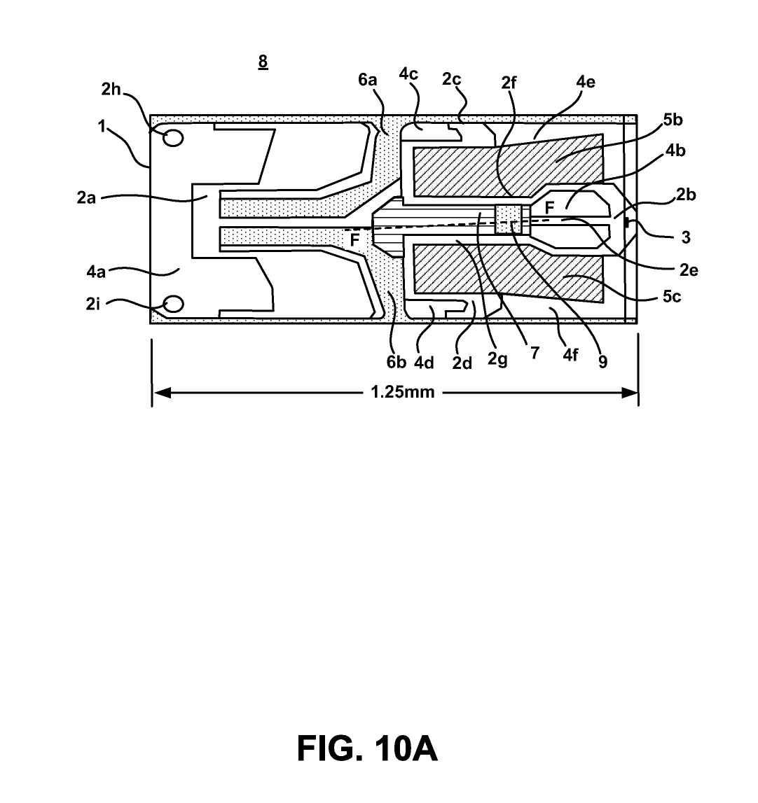

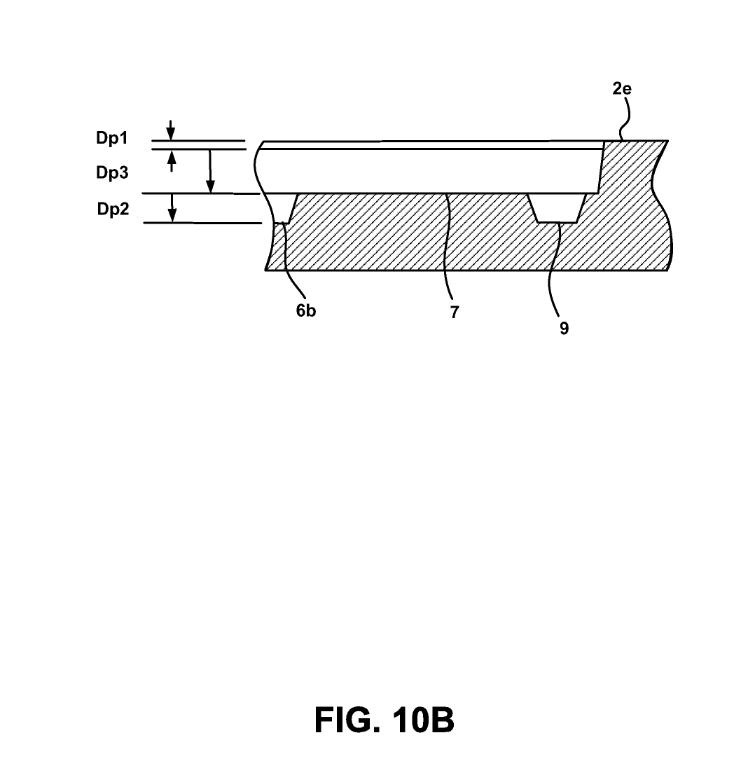

FIG. 10A is a diagrammatic plan view showing the ABS of a head slider according to another embodiment of the present invention. This embodiment is an embodiment in which a pocket 9 is applied to a slider 1 of length 1.25 mm. Levitating surface pads 2h, 2i are provided at the inlet side. FIG. 10B is a cross sectional view along the line F-F of FIG. 10A, showing the shape of the cross section in the vicinity of the pocket 9. The recess depth is shallower in the third deep recessed surface 7 than the depth of the second deep recessed surface 6b, and the peninsula-shaped levitating surface 2e reaches the third deep recessed surface 7. The basic construction is the same as in the case of the first embodiment. This embodiment also has the same beneficial effect as the first embodiment.

### Example 5

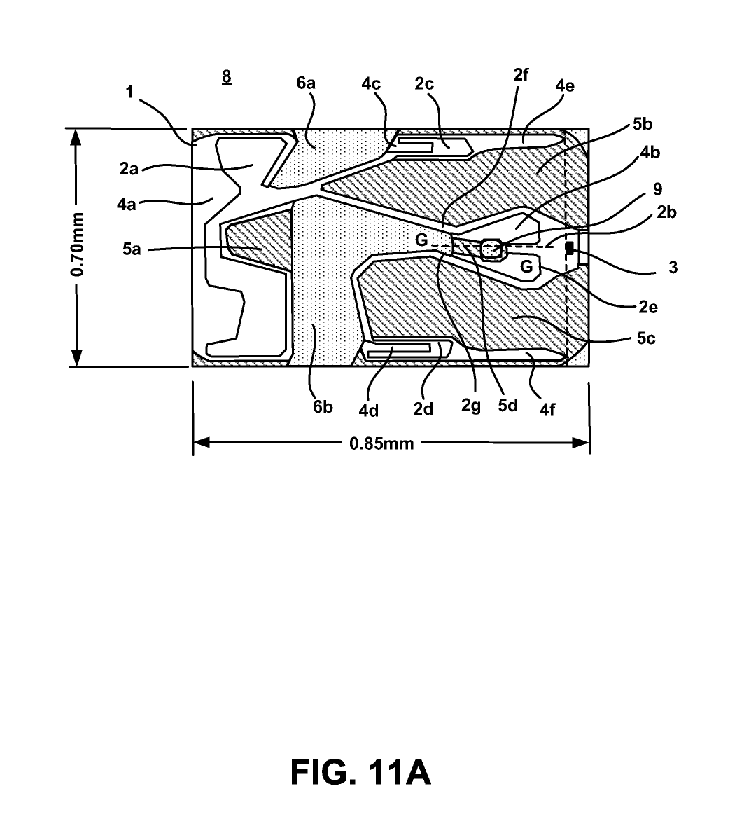

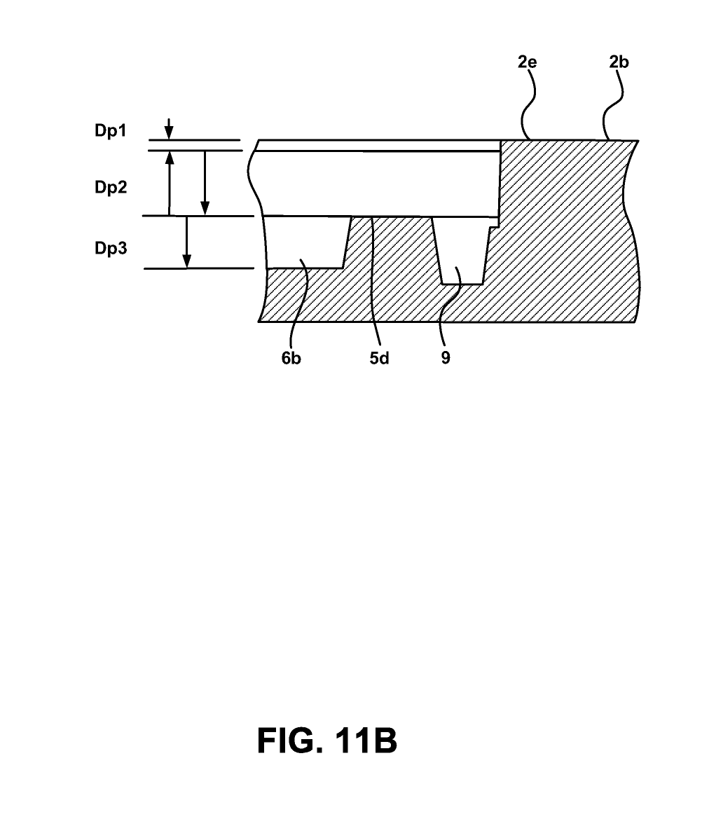

FIG. 11A is a diagrammatic plan view showing the ABS of a head slider according to another embodiment of the present invention. This embodiment is an example in which a deep recessed surface 5d playing the role of a second deep recessed surface extends to the inlet end of the central levitating surface 2b, continuing from the deep recessed surface 6b, and a pocket 9 is provided. FIG. 11B is a cross sectional view along the line G-G of FIG. 11A, showing the cross sectional shape of the vicinity of the pocket 9. The data of the pocket 9 is written to the processing mask used when performing processing (Dp3) of the second deep recessed surface after processing (Dp1) of the shallow recessed surface and processing (Dp2) of the deep recessed surface: this is an example in which the pocket is arranged to be formed by the same processing as the second deep recessed surfaces 6a, 6b. The same beneficial effect as in the case of the first embodiment is obtained by this embodiment also.

### Example 6

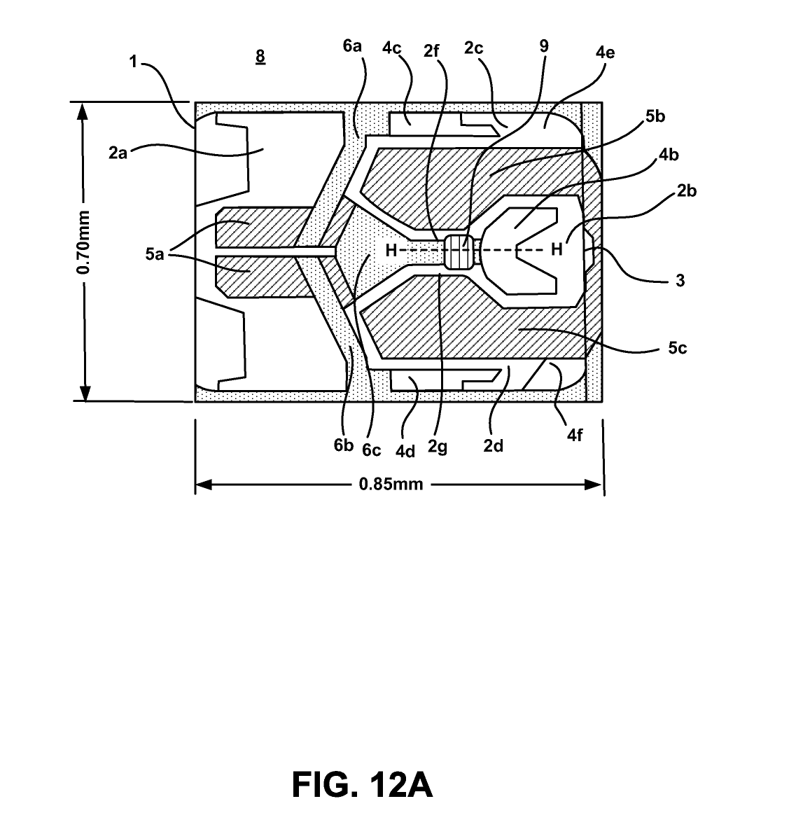

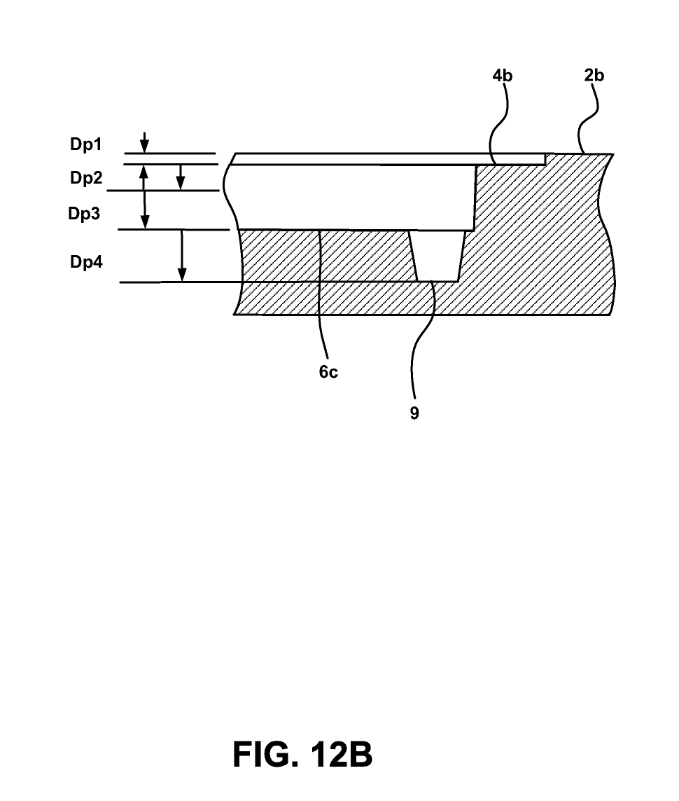

FIG. 12A is a diagrammatic plan view showing the ABS of the head slider according to another embodiment of the present invention. This embodiment is an example in which a pocket 9 is employed in a construction in which the boundary of the shallow recessed surfaces and deep recessed surfaces is between the second deep recessed surfaces 6a, 6b in the middle of the slider 1 and the second deep recessed surface 6c, which constitutes a second deep recessed surface. FIG. 12B is a cross sectional view along the line H-H of FIG. 12A and shows the cross sectional shape in the vicinity of the pocket 9. This is an example in which the pocket 9 is constructed with a depth that is even greater than the depth of the second deep recessed surface 6c, by a depth Dp4. This example has the advantage that, since the pocket 9 is formed by an independent process, the depth of the pocket can be independently selected, albeit it has the drawbacks that the number of processing masks is increased and the processing step becomes longer. The same beneficial effect as in the case of the first embodiment is obtained by this embodiment also.

### Example 7

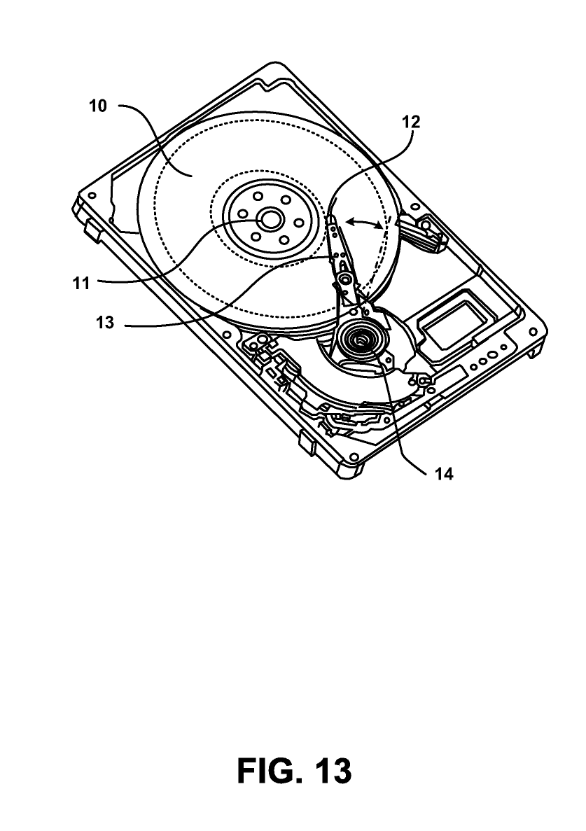

FIG. 13 is a bird's eye view of a magnetic disk drive in which a head slider according to the present invention is mounted. The magnetic disk 10 is driven in rotation by a motor that is fixed to a spindle 11. An arm 13 in which a slider 12 according to the present invention is mounted at the tip is positioned on the desired track on the magnetic disk 10 by driving an actuator 14. Writing or reading of information in respect of the magnetic disk 10 is performed from the magnetic recording head arranged at the rear end of the slider as the slider 12 is levitated over or indirectly contacts the magnetic disk 10 in stable fashion, due to the action of the air bearing.

The foregoing descriptions of specific embodiments of the present technology have been presented for purposes of illustration and description. They are not intended to be exhaustive or to limit the technology to the precise forms disclosed, and many modifications and variations are possible in light of the above teaching. The embodiments described herein were chosen and described in order to best explain the principles of the technology and its practical application, to thereby enable others skilled in the art to best utilize the technology and various embodiments with various modifications as are suited to the particular use contemplated. It is intended that the scope of the technology be defined by the claims appended hereto and their equivalents.

What is claimed is:

1. A head slider with a pocket comprising:
an air bearing surface;
a central levitating surface provided in a center region of said head slider in a width direction at a trailing edge side of said head slider;
a magnetic recording head provided in proximity to a trailing edge side of said central levitating surface;
a deep recessed surface provided on both sides of said head slider in a width direction of said head slider with respect to said central levitating surface, wherein said deep recessed surface is configured to generate negative air pressure;
a second deep recessed surface extending from a leading edge side of said central levitating surface; and
a levitating surface provided on a leading edge side of said deep recessed surface and a second levitating surface provided between said deep recessed surface and said second deep recessed surface, wherein said pocket is provided whose depth from said levitating surface and said second levitating surface is deeper than a periphery immediately in front of a terminus of said second deep recessed surface.

2. The head slider of claim 1 wherein said second deep recessed surface comprises a first recess provided on a leading edge side, whose depth relative to said levitating surface is a first depth, and a second recess connected with said first recess, whose depth relative to said levitating surface is a second depth more shallow than said first depth, and wherein said pocket is provided in said second recess.

3. The head slider of claim 2 provided with a step positioned between said pocket and said central levitating surface whose depth relative to said levitating surface is said second depth.

4. The head slider of claim 2 wherein a depth of said pocket relative to said levitating surface is said first depth.

5. The head slider of claim 1 wherein a width at a top of said pocket is wider than a width at a trailing edge side of said second deep recessed surface.

6. The head slider of claim 1 wherein said second deep recessed surface has a planar shape tapered towards said central levitating surface.

7. The head slider of claim 1 wherein said pocket has a dimension in a direction of extension of said second deep recessed surface that is smaller than a second dimension of said pocket in a direction orthogonal said direction of extension of said second deep recessed surface.

8. The head slider of claim 1 wherein said levitating surface further comprises a peninsula-shaped levitating surface that reaches said second deep recessed surface from said central levitating surface.

9. The head slider of claim 1 having a central shallow recess positioned between said central levitating surface and said second deep recessed surface whose depth relative to said levitating surface is more shallow than said deep recessed surface.

10. A disk drive assembly comprising:
a magnetic disk;
a disk drive section configured to drive said magnetic disk in a rotation;
a magnetic recording head mounted to a head slider, wherein said magnetic recording head performs writing and reading operations with respect to said magnetic disk to store and read information;
a head drive section that positions said magnetic recording head on a desired track of said magnetic disk; and
said head slider further comprising:
an air bearing surface;
a central levitating surface provided in a center region of said head slider in a width direction at a trailing edge side of said head slider;
a magnetic recording head provided in proximity to a trailing edge side of said central levitating surface;
a deep recessed surface provided on both sides of said head slider in a width direction of said head slider with respect to said central levitating surface, wherein said deep recessed surface is configured to generate negative air pressure;
a second deep recessed surface extending from a leading edge side of said central levitating surface; and
a levitating surface provided on a leading edge side of said deep recessed surface and a second levitating surface provided between said deep recessed surface and said second deep recessed surface, wherein said pocket is provided whose depth from said levitating surface and said second levitating surface is deeper than a periphery immediately in front of a terminus of said second deep recessed surface.

11. The disk drive assembly of claim 10 wherein said second deep recessed surface comprises a first recess provided on a leading edge side, whose depth relative to said levitating surface is a first depth, and a second recess connected with said first recess, whose depth relative to said levitating surface is a second depth more shallow than said first depth, and wherein said pocket is provided in said second recess.

12. The disk drive assembly of claim 11 provided with a step positioned between said pocket and said central levitating surface whose depth relative to said levitating surface is said second depth.

13. The disk drive assembly of claim 11 wherein a depth of said pocket relative to said levitating surface is said first depth.

14. The disk drive assembly of claim 10 wherein a width at a top of said pocket is wider than a width at a trailing edge side of said second deep recessed surface.

15. The disk drive assembly of claim 10 wherein said second deep recessed surface has a planar shape tapered towards said central levitating surface.

16. The disk drive assembly of claim 10 wherein said pocket has a dimension in a direction of extension of said second deep recessed surface that is smaller than a second dimension of said pocket in a direction orthogonal said direction of extension of said second deep recessed surface.

17. The disk drive assembly of claim 10 wherein said levitating surface further comprises a peninsula-shaped levitating surface that reaches said second deep recessed surface from said central levitating surface.

18. The disk drive assembly of claim 10 having a central shallow recess positioned between said central levitating surface and said second deep recessed surface whose depth relative to said levitating surface is more shallow than said deep recessed surface.
